(19) United States
(12) Patent Application Publication
(10) Pub. No.: US 2021/0301833 A1
(43) Pub. Date: Sep. 30, 2021

(54) ACOUSTIC FLASHBACK DETECTION IN A GAS TURBINE COMBUSTION SECTION

(71) Applicant: Siemens Energy, Inc., Orlando, FL (US)

(72) Inventors: Joshua S. McConkey, Orlando, FL (US); Tao Cui, Princeton Junction, NJ (US)

(21) Appl. No.: 17/262,649

(22) PCT Filed: Jul. 24, 2018
(86) PCT No.: PCT/US2018/043454

§ 371 Date: Jan. 22, 2021

(51) Int. Cl. F04D 29/66; F23N 5/16

(52) U.S. Cl. CPC F04D 29/66; F05D 2260/96; F23R 2900/00013; F23N 5/16

(57) ABSTRACT

A method of detecting combustor flashback in a gas turbine engine includes positioning a dynamic pressure sensor within a combustion section having a flame tube, providing a flow of fuel to the gas turbine engine, and operating the gas turbine engine to establish a flame having a flame front spaced a non-zero distance from an outlet of the flame tube. The method also includes detecting pressure changes adjacent the flame tube to produce pressure signals, monitoring the amplitude of the signals provided by the dynamic pressure sensor, detecting a flashback signal within the signals provided by the dynamic pressure sensor, and varying the fuel flow in response to the detection of the flashback signal.

### TECHNICAL FIELD

The present disclosure is directed, in general, to the detection of flame irregularities, and more specifically to the detection of irregularities such as flashback in gas turbine engines.

### BACKGROUND

A gas turbine engine is a flow machine in which a pressurized high-temperature gas is expanded to produce mechanical work. The gas turbine includes a turbine or expander, a compressor positioned upstream of the turbine, and a combustion chamber between the compressor and turbine. The compressor section compresses air by way of the blading of one or more compressor stages. The compressed air subsequently mixes with a gaseous or liquid fuel in the combustion chamber, where the mixture is ignited to initiate combustion. The combustion results in a hot gas (a mixture composed of combustion gas products and residual components of air) which expands in the following turbine section, with thermal energy being converted into mechanical energy in the process to drive an axial shaft. The shaft is connected to and drives the compressor. The shaft also drives a generator, a propeller or other rotating loads. In the case of a jet power plant, the thermal energy also accelerates a hot gas exhaust stream, which generates the jet thrust. Flashback is a phenomenon that occurs in the combustion chambers of gas turbines when the flame front moves backward against the fuel/air flow and approaches or contacts a flame tube.

### SUMMARY

A method of detecting combustor flashback in a gas turbine engine includes positioning a dynamic pressure sensor within a combustion section having a flame tube, providing a flow of fuel to the gas turbine engine, and operating the gas turbine engine to establish a flame having a flame front spaced a non-zero distance from an outlet of the flame tube. The method also includes detecting pressure dynamics adjacent the flame tube to produce pressure signals, monitoring the characteristic of the signals provided by the dynamic pressure sensor, detecting a flashback signature within the signals provided by the dynamic pressure sensor, and varying the fuel flow in response to the detection of the flashback signature.

In another construction, a method of detecting flashback in a gas turbine engine that includes a combustion section having at least two combustor baskets and at least one flame tube in each basket includes providing a flow of fuel to the gas turbine engine, operating the gas turbine engine to establish a flame having a flame front spaced a non-zero distance from an outlet of each of the flame tubes, and positioning a dynamic pressure sensor adjacent each combustor basket to monitor the acoustic environment within each combustor basket. The method also includes positioning a vibration sensor adjacent each combustor basket to measure vibration of each combustor basket, detecting one of a chirp signal and a difference in vibration signal between two combustor baskets, and varying the flow of fuel in response to detection of one of the chirp signal and the difference in vibration signal.

In another construction, a method of detecting flashback in a gas turbine engine that includes a combustion section having a plurality of combustor baskets and at least one flame tube in each combustor basket includes operating the gas turbine engine to establish a flame having a flame front spaced a non-zero distance from an outlet of each of the flame tubes, and positioning a vibration sensor adjacent each combustor basket to measure vibration of each combustor basket. The method also includes comparing the measured vibration of each basket of the plurality of baskets to each remaining basket of the plurality of baskets to identify vibration events in individual baskets, and identifying any basket that includes a vibration event above a predetermined threshold.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this specification and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 is a is a partial cross section of a gas turbine engine.

FIG. 2 is a cross section of a portion of the gas turbine engine of FIG. 1 including acoustic transducers.

FIG. 3 is schematic illustration of a flame tube and flame showing the space between the flame tube and a flame front.

FIG. 4 is a group of charts illustrating data collected from at least one dynamic pressure sensor and from at least one thermocouple during a flashback event.

FIG. 5 is a group of charts illustrating data collected from a vibration sensor during normal operation.

FIG. 6 is a group of charts illustrating data collected from the vibration sensor during another flashback event.

FIG. 7 is a group of charts illustrating raw data collected from the vibration sensor and the signature vibration level extracted from the raw data from the vibration sensors installed on two baskets on a gas turbine, and the temperature data from one thermocouple that shows temperature increase due to flashback during a flashback event.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Also, it should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean: that an element is relatively near to but not in contact with a further element; or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard as available a variation of 20 percent would fall within the meaning of these terms unless otherwise stated.

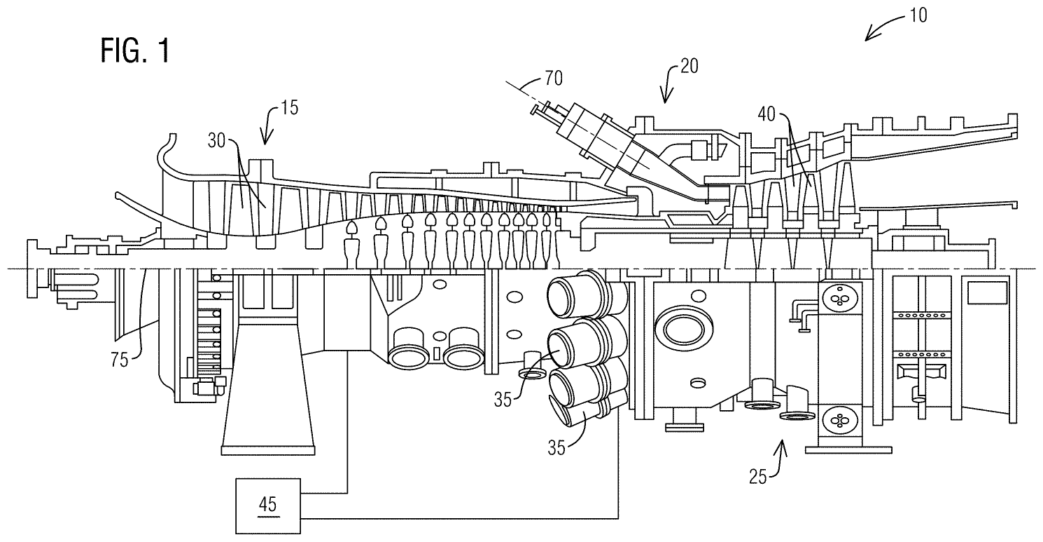

FIG. 1 illustrates an example of a gas turbine engine 10 including a compressor section 15, a combustion section 20, and a turbine section 25. The compressor section 15 includes a plurality of stages 30 with each stage including a set of rotating blades and a set of stationary or adjustable guide vanes. The compressor section 15 is in fluid communication with an inlet section to allow the engine 10 to draw atmospheric air into the compressor section 15. During engine operation, the compressor section 15 operates to draw in atmospheric air and to compress that air for delivery to the combustion section.

In the illustrated construction, the combustion section 20 includes a plurality of separate combustors 35 that each operate to mix a flow of fuel with the compressed air from the compressor section 15 and to combust that air-fuel mixture to produce a flow of high temperature, high pressure combustion gases. Of course, many other combustion section arrangements are possible.

The turbine section 25 includes a plurality of stages 40 with each stage 40 including a number of rotating blades and a number of stationary blades or vanes. The stages 40 are arranged to receive the combustion gas from the combustion section 20 and expand that gas to convert thermal and pressure energy into rotating or mechanical work. The turbine section 25 is connected to the compressor section 15 to drive the compressor section 15. For gas turbine engines 10 used for power generation or as prime movers, the turbine section 15 is also connected to a generator, pump, or other device to be driven. In the case of jet engines, the combustion gas is discharged from the engine to produce thrust.

A control system 45 is coupled to the gas turbine engine 10 and operates to monitor various operating parameters and to control various operations of the gas turbine engine 10. In preferred constructions the control system 45 is micro-processor based and includes memory devices and data storage devices for collecting, analyzing and storing data. In addition, the control system 45 provides output data to various devices including monitors, printers, indicators, and the like that allow users to interface with the control system 45 to provide inputs or adjustments. In the example of a power generation system, a user may input a power output set point and the control system 45 adjusts the various control inputs to achieve that power output in an efficient manner.

The control system 45 can control various operating parameters including, but not limited to variable inlet guide vane positions, fuel flow rates and pressures, engine speed, and generator load. Of course, other applications may have fewer or more controllable devices. The control system 45 also monitors various parameters to assure that the gas turbine engine 10 is operating properly. Some parameters that are monitored may include inlet air temperature, compressor outlet temperature and pressure, combustor outlet temperature, turbine inlet temperature, fuel flow rate, generator power output, and the like. Many of these measurements are displayed for the user and are logged for later review should such a review be necessary.

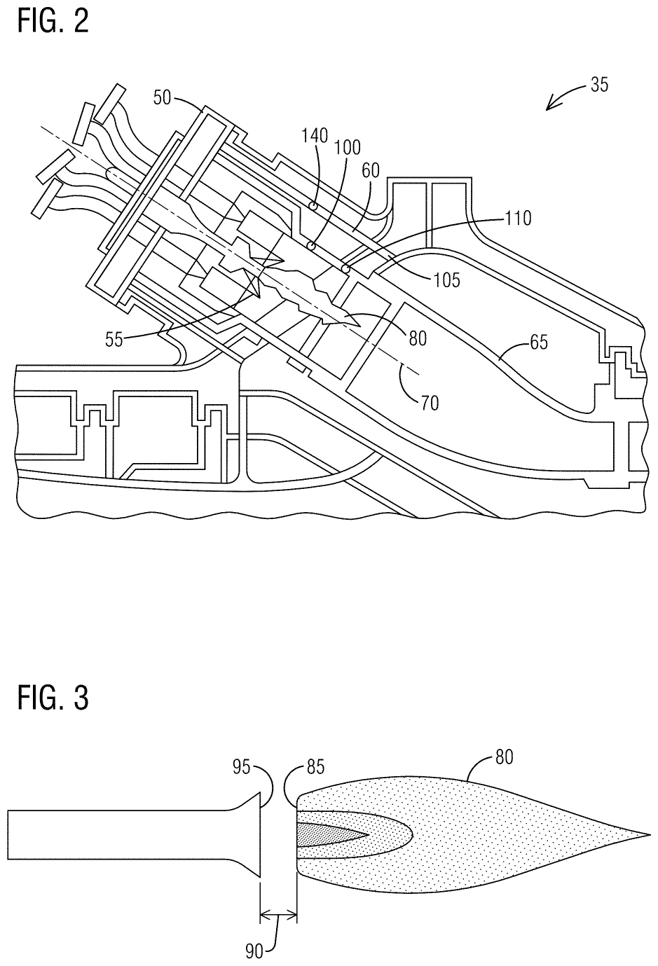

FIG. 2 is an enlarged cross-sectional view of one of the combustors 35 of the gas turbine engine 10 of FIG. 1. Each combustor 35 includes a top hat section 50, at least one flame tube 55, a combustor basket 60, and a transition piece 65. The top hat section 50 attaches to the engine 10 and supports any piping and valves necessary to direct fuel into the combustor 35. The combustor basket 60 extends from the top hat section 50 toward the turbine section 25 and defines a long axis 70 that is arranged at an oblique angle with respect to a gas turbine engine central axis 75. The combustor basket 60 operates as a liner to separate the combustion zone of the combustor 35 from the exterior walls of the engine 10. At least one flame tube 55, and in many cases multiple flame tubes 55 are disposed within the combustor basket 60. The flame tubes 55 expel a flow of fuel and air that is ignited to form one or more flames 80 within the combustor basket 60. During normal operation, the flame 80 defines a flame front 85 (shown in FIG. 3) that is spaced a non-zero distance 90 from an outlet 95 of the flame tube 55. The combustor basket 60 includes a plurality of apertures (not shown) that allow additional air into the combustion area to assure complete combustion and to cool the combustion gases before they are discharged to the turbine section 25. The transition piece 65 is positioned adjacent the combustion baskets 60 to receive the combustion gases and direct them efficiently to the inlet of the turbine section 25.

With reference to FIG. 2, a first sensor 100 is positioned at an outlet end 105 of the combustor basket 60 and a second sensor 110 is positioned in the transition piece 65 downstream of the first sensor 100. Thus, in the illustrated construction, the sensors 100, 110 are downstream of the flame tube 55. The sensors 100, 110 are dynamic pressure sensors that are operable to detect small and rapid pressure changes associated with auditory changes within the combustor 35. While two sensors 100, 110 are illustrated, only one is required to detect the desired pressure fluctuations. In other constructions, these sensors 100, 110 can be positioned in the top hat section 50 or in other areas of the combustor 35. The actual position and quantity of sensors 100, 110 required can vary with the design of the combustor 35 as small design changes can have a large effect on the acoustic environment.

Other sensors, such as acoustic sensors, low frequency pressure sensors, temperature sensors, optical sensors, or ionization sensors, alone or in some combination can be configured to detect physical phenomena in at least a portion of the gas flow. In some embodiments, there are multiple actuators or sensors or both, collectively called transducers. In some embodiments, either or both of one or more actuators and sensors are acoustic transceivers that are acoustic transducers that can both emit and detect acoustic signals.

The dynamic pressure sensors 100, 110 receive acoustic oscillations generated within the combustor 35, including those generated by the flame 80 and convert those oscillations into signals that can be analyzed by a processor. The status of the flame 80 can be reliably detected and monitored by combining information about the locations of the sensors 100, 110 and the flame 80 with the spectral content contained in the sensor signals. In various embodiments described herein, information about the position of the flame front 85 is also determined based on the spectral content of the signals received from either or both the dynamic pressure sensors 100, 110. The dynamic pressure sensors 100, 110 are arranged at two different locations in the pressure influence zone of the combustor 35 in the gas turbine engine 10. What is understood by pressure influence zone in this context is an area where pressure fluctuations are dependent to a large extent on the dynamics of the flame 80 of the respective combustor 35. In the case of a gas turbine engine 10 of the can-annular type this can be for example an area within the respective basket 60 of the combustor 35. In other embodiments, different acoustic transducers in the same or different one or more locations sensitive to acoustic phenomena in the combustor basket 60 are used. In some constructions, the pressure sensors 100, 110 are positioned upstream from the flame 80. This location is colder than the sensor location shown in FIG. 2. However, FIG. 2 is provided to explain how flame monitoring with sensors 100, 110 is done to aid in identifying the problematic phenomena, including flashback in or adjacent to the flame tube 55.

Thus, there are dynamic pressure sensors 100, 110 mounted on each basket 60 in a can-annular combustor system or a few in the annulus in the case of an annular chamber. From the results obtained by advanced data acquisition systems, these sensors 100, 110 are sensitive enough to pick up the sound created by events such as a flashback event.

The dynamic pressure sensors 100, 110 are used as part of a flashback detection system that is implemented as part of the control system 45 or is a stand-alone monitoring system. During normal operation of the gas turbine engine 10, flames 80 are supported a non-zero distance 90 from each of the flame tubes 55 (shown in FIG. 3). The base of the flame 80 or the flame front 85 tends to move in response to varying operating conditions (e.g., fuel pressure, fuel flow, air pressure, air volume, temperature, etc.). Under certain conditions, the flame front 85 can get very close to the flame tube outlet 95 or even move into the flame tube 55. This condition is referred to as flashback and can cause rapid and significant damage to the flame tube 55 and other turbine engine components. The flashback detection system monitors the dynamic pressure sensors 100, 110 for a characteristic signal indicative of a flashback event. Often, the characteristic that indicates a flashback event is an increase in amplitude in a particular frequency range.

With reference to FIG. 3, the flame tubes 55 are annular tube members that during normal operation vibrate due to the flow passing through them. The flame front 85 for each flame tube 55 cooperates with its corresponding flame tube 55 to define a characteristic length. The characteristic length establishes the frequencies at which the individual flame tube 55 vibrates. At the initiation of a flashback event, the flame front 85 moves closer to the flame tube 55. This shortens the characteristic length and increases the amplitude and frequency of the vibrations produced by the flame tube 55.

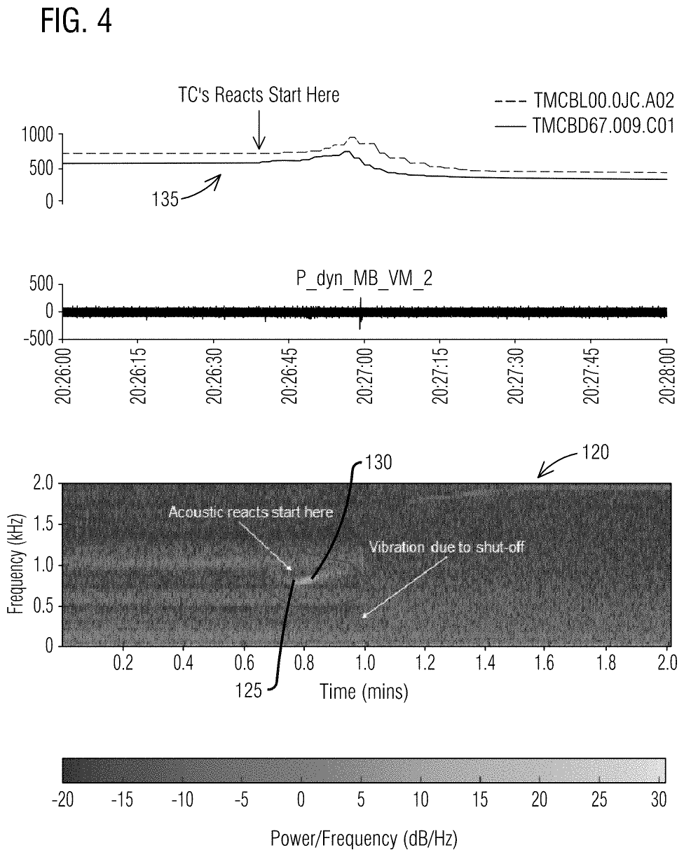

FIG. 4 illustrates a series of charts including a spectrogram 120 generated by the dynamic pressure sensors 100, 110 and showing the frequency ranges in which the flame tubes 55 vibrate. During the flashback event, the dynamic pressure sensors 100, 110 detect the increased amplitude 125 immediately. In addition, as the flame front 85 approaches the outlet 95 of the flame tube 55 it shortens the characteristic length which increases the vibration frequency. This immediately appears as a higher amplitude line 130 that increases in frequency with time.

Prior art detection systems relied on thermocouples to detect increases in temperatures. FIG. 4 also illustrates a thermocouple plot 135 of the same flashback event illustrated in the spectrogram 120. The dynamic pressure sensors 100, 110 detect the flashback event almost instantaneously. However, the thermocouple system requires some time to heat the thermocouple. In addition, a deadband or tolerance is provided for the thermocouple system to inhibit unwanted false positive detections. Thus, the dynamic pressure sensor system detects and reacts to a flashback event before the thermocouple system detects the event. Detecting the flashback early can provide an operator or control system time to reduce the fuel flow to the combustor 35 or to shutdown the gas turbine engine 10 to reduce the likelihood of damage.

In engines 10 with combustor baskets 60 that include multiple flame tubes 55, two or more dynamic pressure sensors 100, 110 can be used simultaneously to identify the specific flame tube 55 that is experiencing the flashback event. With the sensors 100, 110 spaced apart, a triangulation method or other known methods can be used to identify the location of the vibration event. The flame tube 55 that experiences the event can than be identified for future inspection, maintenance, or replacement.

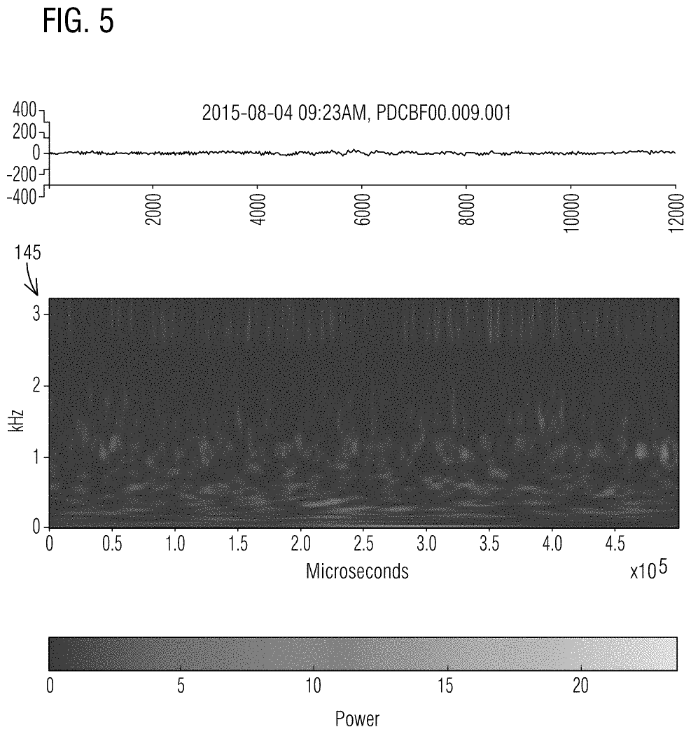

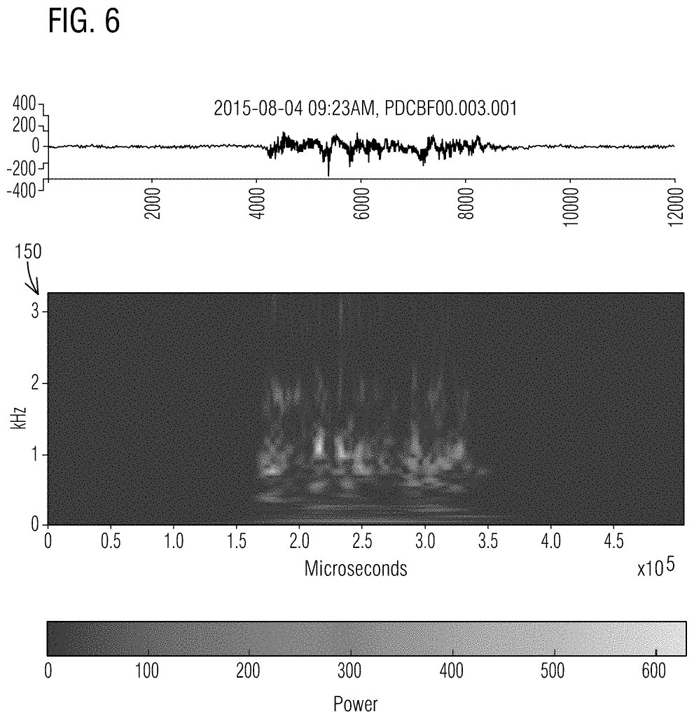

In another construction, vibration sensors 140 are coupled to the individual combustor baskets 60 to detect vibration of the baskets 60. During operation of the engine 10, each of the individual baskets 60 tends to vibrate within the same range of frequencies. FIG. 5 includes another spectrogram illustrating the data generated by the vibration sensors 140 during normal operation. However, during a flashback event there is often an increased amplitude of the vibration within a particular frequency range of the combustor basket 60 in which the flashback event occurs, as illustrated in the spectrogram 150 of FIG. 6. The control system 45 compares the vibration levels of all the combustor baskets 60 simultaneously and identifies which combustor basket 60 is generating the anomalous vibrations. The events are logged as possible flashback events to allow for future inspection, maintenance, or replacement.

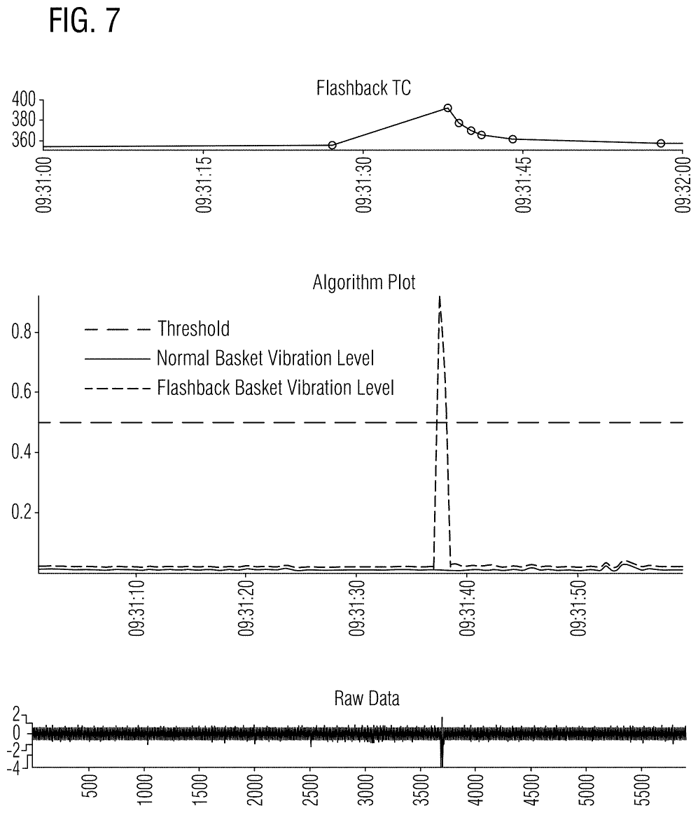

FIG. 7 illustrates the vibration data in a different format. In FIG. 7, the vibration levels within the particular frequency range for each sensor 140 on multiple baskets are plotted versus time. A spike or sudden large increase of the vibration level from one vibration sensor 140 installed on one basket 60 with respect to the normal vibration level from sensors 140 installed on other baskets 60 is indicative of an event such as a flashback event on the basket 60 experiencing the spike. FIG. 7 also illustrates the reaction of a temperature-based flashback detection system under the same operating conditions. As with the dynamic pressure sensor system, the vibration sensors 140 react more quickly to the flashback event than does the temperature-based system.

In some embodiments, the spectrograms 120, 145 are presented to a user on a display, such as a display device of a computer system to allow for continuous and real time monitoring of the engine 10. In addition, the data is capable of automated analysis which allows for automated alarming or logging of events that appear to be flashback events.

While much of the disclosure discusses monitoring two combustor baskets, it should be clear that the flashback detection system is capable of monitoring any number of combustor baskets simultaneously.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A method of detecting combustor flashback in a gas turbine engine, the method comprising:
positioning a dynamic pressure sensor within a combustion section having a flame tube;
providing a flow of fuel to the gas turbine engine;
operating the gas turbine engine to establish a flame having a flame front spaced a non-zero distance from an outlet of the flame tube;
detecting pressure changes adjacent the flame tube to produce pressure signals;
monitoring a characteristic of the signals provided by the dynamic pressure sensor;
detecting a flashback signature within the signals provided by the dynamic pressure sensor; and
varying the fuel flow in response to the detection of the flashback signature.

2. The method of claim 1, wherein the combustion section includes a plurality of separate combustor baskets and wherein the dynamic pressure sensor is positioned to detect pressure changes within a first of the combustor baskets.

3. The method of claim 2, wherein the flame tube is positioned within the first combustor basket, and wherein each combustor basket includes at least one flame tube.

4. The method of claim 3, wherein the first combustor basket includes a plurality of flame tubes and wherein the dynamic pressure sensor detects pressure changes from each of the plurality of flame tubes simultaneously.

5. The method of claim 4, further comprising positioning a vibration sensor adjacent each of the plurality of combustor baskets, each vibration sensor measuring vibrations of its respective combustor basket and generating signals indicative of those measured vibrations.

6. The method of claim 5, further comprising comparing the measured vibrations between the vibration sensors and identifying a measured vibration from one vibration sensor that is not present in the other measured vibrations.

7. The method of claim 4, further comprising positioning a second dynamic pressure sensor adjacent the first combustor basket to detect pressure changes adjacent the plurality of flame tubes within the first combustor basket, and determining which of the plurality of flame tubes is generating pressure changes based on the signals from the dynamic pressure sensor and the second dynamic pressure sensor.

8. The method of claim 1, wherein the flashback signal includes an increase in amplitude that increases in frequency with time.

9. The method of claim 1, wherein varying the fuel flow includes reducing the fuel flow to zero to shutdown the gas turbine engine.

10. The method of claim 1, wherein the positioning step includes positioning the dynamic pressure sensor downstream of the flame tube.

11. A method of detecting flashback in a gas turbine engine that includes a combustion section having at least two combustor baskets and at least one flame tube in each basket, the method comprising:
providing a flow of fuel to the gas turbine engine;
operating the gas turbine engine to establish a flame having a flame front spaced a non-zero distance from an outlet of each of the flame tubes;
positioning a dynamic pressure sensor adjacent each combustor basket to monitor an acoustic environment within each combustor basket;
positioning a vibration sensor adjacent each combustor basket to measure vibration of each combustor basket;
detecting one of a chirp signal and a difference in vibration signal between two combustor baskets; and
varying the flow of fuel in response to detection of one of the chirp signal and the difference in vibration signal.

12. The method of claim 11, wherein each combustor basket includes a plurality of flame tubes and wherein each dynamic pressure sensor detects pressure changes from each of the plurality of flame tubes within its respective combustor basket simultaneously.

13. The method of claim 11, further comprising comparing the measured vibrations between the vibration sensors to generate difference in vibration signals and identifying a difference in vibration signal from one vibration sensor that is not present in the other vibration sensors.

14. The method of claim 11, wherein each combustor basket includes a plurality of flame tubes.

15. The method of claim 14, further comprising positioning a second dynamic pressure sensor adjacent each combustor basket to detect pressure changes adjacent the plurality of flame tubes within each respective combustor basket, and determining which of the plurality of flame tubes is generating pressure changes based on the signals from the dynamic pressure sensor and the second dynamic pressure sensor for each combustor basket.

16. The method of claim 11, wherein the chirp signal includes a pressure signal that increases in amplitude and increases in frequency with time.

17. The method of claim 11, wherein the difference in vibration signal includes a vibration signal indicative of a vibration at a first of the combustor baskets that is not detected at a plurality of the other combustor baskets.

18. The method of claim 11, wherein varying the fuel flow includes reducing the fuel flow to zero to shutdown the gas turbine engine.

19. The method of claim 11, wherein the positioning step includes positioning the dynamic pressure sensor downstream of the flame tube.

20. A method of detecting flashback in a gas turbine engine that includes a combustion section having a plurality of combustor baskets and at least one flame tube in each combustor basket, the method comprising:
operating the gas turbine engine to establish a flame having a flame front spaced a non-zero distance from an outlet of each of the flame tubes;
positioning a vibration sensor adjacent each combustor basket to measure vibration of each combustor basket;
comparing the measured vibration of each basket of the plurality of baskets to each remaining basket of the plurality of baskets to identify vibration events in individual baskets; and
identifying any basket that includes a vibration event above a predetermined threshold.

21. The method of claim 20, wherein the identifying step includes identifying any basket that includes a vibration event that is not identified in a plurality of the remaining combustor baskets.
